(19) United States
(12) Patent Application Publication
(10) Pub. No.: US 2012/0166928 A1
(43) Pub. Date: Jun. 28, 2012

(54) FIELD EXTENSIBILITY IN SERVICE INTERFACES AND FORMS MESSAGE TYPES

(75) Inventors: Andre Stern, Ladenburg (DE); Saikrishna Gollapudi, Bangalore (IN); Frank Erle, Schriesheim (DE); Uwe Schlarb, Ostringen (DE); Visvapriya Sathiyam, Bangalore (IN); Vinit Kumar, Bilaspur (IN); Ritesh Kumar Dokania, Kumardhubi (IN); Christoph Birkenhauer, Wiesloch (DE); Stefan Baeuerle, Rauenberg-Rotenberg (DE); Bernhard Thimmel, Edingen-Neckarhausen (DE); Matthias Lehr, Weinheim (DE); Sathish Babu Krishna Vihar, Bangalore (IN); Karsten Fanghänel, Schwetzingen (DE)

(73) Assignee: SAP AG, Walldorf (DE)

(21) Appl. No.: 12/977,822

(22) Filed: Dec. 23, 2010

(51) Int. Cl. G06F 17/00

(52) U.S. Cl. 715/223

(57) ABSTRACT

A program and corresponding method allow for the enablement of customizable extension fields into a form template, independent of the field type of the extension field. New extension fields corresponding to section headers of the form template can be created and added to a user interface. A new extension field can drive the form template and be added to all applicable section headers in the form template from the user interface.

### FIELD OF THE INVENTION

The present invention relates to a process for propagating extension fields into a form message type. The present invention further relates to a process for adding new extension fields and enabling hidden extension fields into the form message type.

### BACKGROUND INFORMATION

To add extension fields to various customer forms, invoices, or other templates, programs such as Adobe® LiveCycle® enterprise suite are often used. Such programs allow a user to modify XML-based form templates such as XDP files, which result in PDF files after being rendered by Adobe® Document Services, to achieve a desired outlook for the form template. These programs provide various predefined extension fields that may be merged with existing XML content to create a desired form. A user who wishes to customize a form with additional extension fields may enable or disable the predefined extension fields to output a desired form. If a user wishes to add an extension field to the form, they may parse through the predefined extension fields and enable it to be shown on the form template. If a user wishes to remove an existing extension field from a form, they may parse through the predefined extension fields and select the extension field to be hidden from the form template. After data is input into the desired extension fields, a form is generated corresponding to the input data for the displayed extension fields.

Although such programs may allow for the adding and removal of extension fields from a form template, these programs are restricted to simply enabling or disabling predefined extension fields in the program. A user who wishes to add a new extension field (and corresponding data) to a form template is restricted from creating their own extension field and must use a predefined extension field. If none of the predefined extension fields correspond to a desired extension field of the user, the user cannot customize the form template to include that desired extension field. These programs impose a significant limitation on the user for the customization of the form templates and restrict the user from adding, and subsequently editing, any extension field that is not already provided by the original program. The user is restricted to only adding extension fields that were developed and provided for at the creation of the original program which ignores the need for extension fields which may correspond to subsequently derived technology, information, or concepts. A user cannot use a field type that has not been predefined by the designer.

Thus there remains a need in the art, for a method and system that allows for the customizability of a form template by allowing for the creation of new extension fields and adding these newly created extension fields to the form template. There also remains a need in the art, for the subsequent removal and editing of such user created extension fields.

### BRIEF DESCRIPTION OF THE DRAWINGS

FIG. 1 is a block diagram of an application executed by a processor of the present invention.

FIG. 2 is a diagram of the application of the present invention during a run-time environment.

FIG. 3 is a diagram of the application of the present invention during adaptation mode.

FIG. 4 is a diagram of the field extensibility entities created during run-time operation.

FIG. 5 is a diagram of the application of the present invention driving a customized extension field into a form template.

FIG. 6 is a diagram of the application adding a customized extension field to a form template from the user interface.

### DETAILED DESCRIPTION

The subject invention will now be described in detail for specific preferred embodiments of the invention, it being understood that these embodiments are intended only as illustrative examples and the invention is not to be limited thereto.

Non-customizable programs restrict the creation and addition of user developed extension fields from being integrated into form templates. Embodiments of the present invention provide a program executed on a processor that allows for the addition of user-created extension fields that are integrated into a form template. The executed program further allows for the subsequent editing and removal of the user-created extension fields and may be displayed on a computer or a comparable device with a displayable interface. The present invention corresponds to a process that provides flexibility for the addition of new extension fields of different field types.

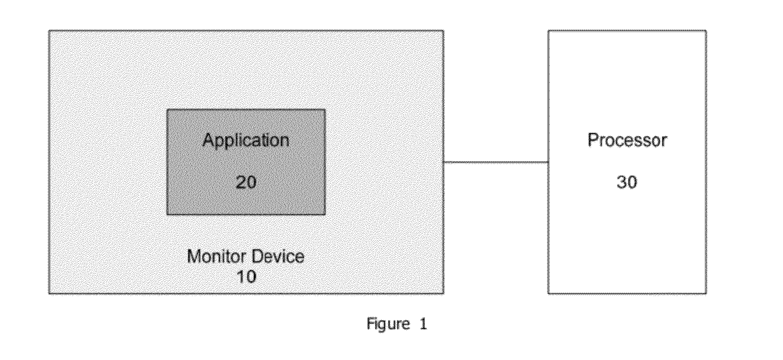

FIG. 1 illustrates a diagram of a monitor 10 displaying an output of application 20 of the present invention. Application 20 may be executed by processor 30 and may result in an output to be displayed on monitor 10 to a user. Monitor 10 may be a computer monitor, or any other display device which may depict application 20 during execution.

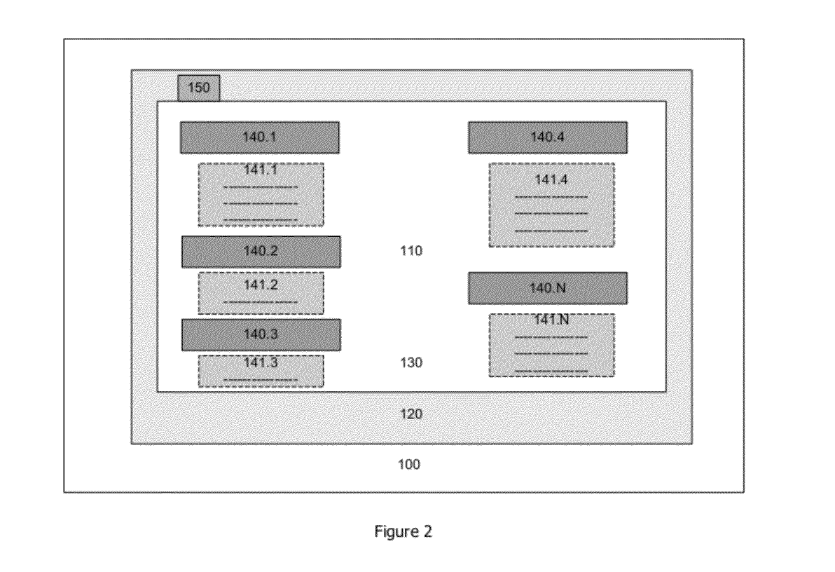

FIG. 2 illustrates application 20 during a run-time environment. Application 20 may contain interface 100 which may display entry fields for a form template 110 that may be selected by a user for displaying in window 120. The type of form template may be selectively chosen from a list of existing templates and added to window 120. In an embodiment, form template 110 may be any of a variety of items including a sales order or customer invoice and data for the form template may be entered in panel 130. Panel 130 may display section headers 140.1-140.N and extension fields 141.1-141.N from the form template 110, and may allow for the user to input data for each respective extension field. The extension fields 141.1-141.N in panel 130 may be separated in various sections of form template 110, under each of the section headers 140.1-140.N. Sections headers 140.1-140.N may correspond to sections such as “Account”, “Delivery”, and “Payment” in an embodiment where form template 110 is a sales order or sales confirmation. A user may input data values corresponding to the section headers and their respective extension fields.

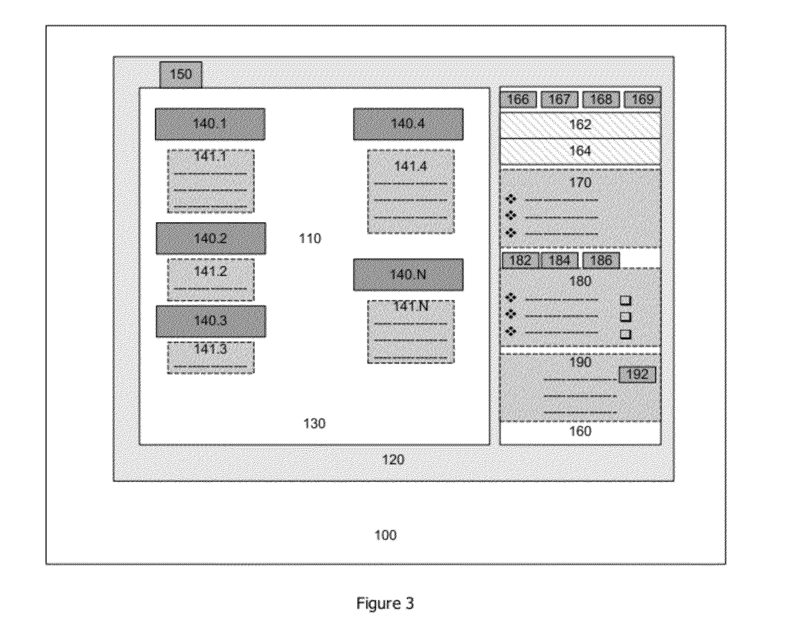

Window 120 may contain menu bar 150 displayed above panel 130. Menu bar 150 may be labeled as “Adapt” which may allow for the application to run in an adaptation mode. During adaptation mode, a user may make changes to the layout of form template 110 as well as adding additional extension fields to form template 110. FIG. 3 illustrates application 20 in adaptation mode. In adaptation mode, the width of panel 130 may be reduced and may no longer fill most of window 120. An additional panel 160 may appear adjacent to panel 130. Panel 160 may have the same length of panel 130. Panel 160 may contain a tab 162 corresponding to the screen layout and a tab 164 corresponding to the extension fields of form template 110. Panel 160 may also have buttons 166-169 that may allow for the saving, publishing, discarding, and reversion of any changes made to the screen layout or extension fields in adaptation mode. Tab 162 may be designated as “Screen Layout” and tab 164 may be designated as “Extension Fields”. Clicking on tab 164 may display a list box 170 listing section headers 140.1-140.N from form template 110, with the names of the section headers displayed in the list box. One of section headers 140.1-140.N may be selectively chosen by scrolling up or down through list box 170 using a mouse, a keyboard, or any other user input device. A selection of one of the section headers may display a list box 180 listing the extension fields in the selected header. List box 180 may also display a column detailing the visibility of each of the displayed extension fields. Visibility of the extension field may be enabled or disabled from interface 100 by checking or unchecking the box in the visibility column next to each extension field. Enabling the extension may allow for the visibility and the input of data for that extension field in panel 130.

List box 180 may have an add button 182 which may allow for adding a new extension field to the selected section header in list box 170. If an extension field is added in list box 180, it may be displayed in panel 130. Selecting add button 182 may display key user tool 190. Key user tool 190 may display and edit the properties of a selected extension field, or through multiple user inputs, allow for a user to provide information about a newly added extension field, including the business context of the field (where the extension field is added), a field type, and a label for extension field. Types of business contexts may include sales orders, for example, or customer return receipts. If an existing extension field is selected in list box 180, then key user tool 190 may display the previously input field properties of the extension field. If a user wishes to edit the previously inputted field properties for an extension field, they may select an extension field in list box 180 and click on edit button 184 which may provide for editing the properties of the selected extension field. Key user tool 190 may be displayed with the previously input field properties of the extension, and a user may click on the desired input to edit it. Removal of an extension field from the selected section header in list box 170 may be made be clicking on a desired extension field in list box 180 and clicking on remove button 186. Removing an extension field from list box 180 may delete the extension field from panel 130 and may make the extension field unavailable if the user wishes to add it to form template 110.

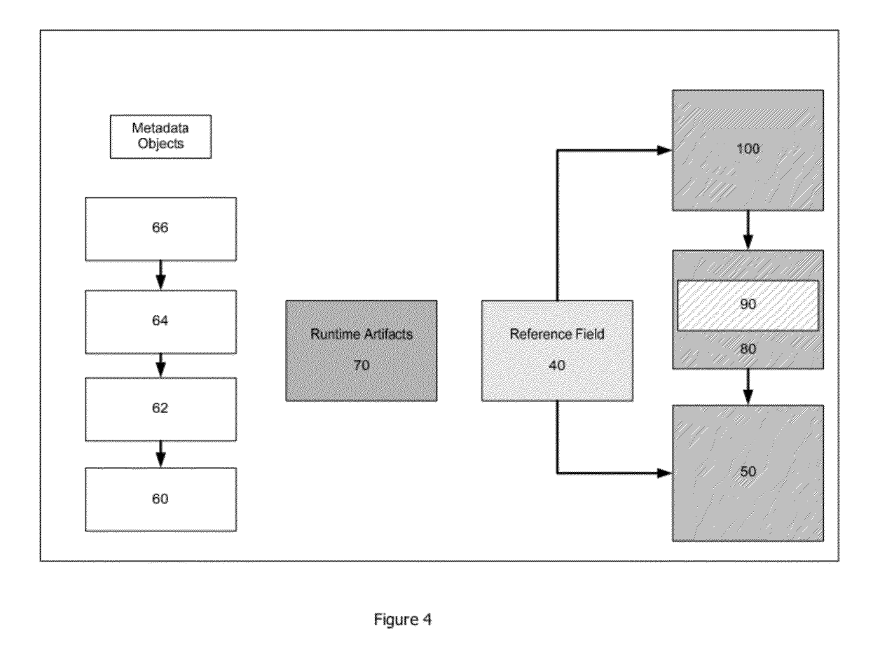

When a new extension field is added in list box 180, the added extension field may generate a reference field 40 that points to the user interface 100 as illustrated in FIG. 4. The reference field 40 may correspond to the business context as input by the user, and thus may point to a corresponding field in the user interface and to a corresponding business object node 50. From the user input information of the field properties in key user tool 190, metadata objects 60-66 may be created. Metadata object 60 may correspond to the “Field definition” of reference field 40 and may contain information on the type or label of the field as input by a user through key user tool 190. Metadata object 62 may contain the field definition information as created in metadata object 60 and information as to which business node reference field 40 may be connected to. Metadata object 64 may indicate that the described field in metadata object 62 may be added to user interface 100. Metadata object 66 may describe the positioning of reference field 40 on user interface 100.

When a new extension field is added, metadata objects 60-66 and the field definition of reference field 40 are read. Runtime artifacts 70 may be created by a field extensibility generator and may only be stored locally. A determination may be made as to the specific controller node 80 to add reference field 40, and the runtime model 90 to use. If an extension field or a business object is changed, runtime artifacts 70 may be deleted and regenerated.

If an extension field is edited in list box 180, reference field 40 may be adapted to reflect the changes to the extension field. The reference field 40 may subsequently point to a different field in the user interface and to a difference business object. Metadata objects 60-66 may change to reflect the changes to the field definition or other edited information. The metadata objects 60-66 may contain information as to the new business node reference field 40 is connected to, and where reference field 40 is added on interface 100. Previously generated runtime artifacts 70 may be deleted, and when the adapted metadata objects 60-66 and reference field 40 are read again, new runtime artifacts may be created.

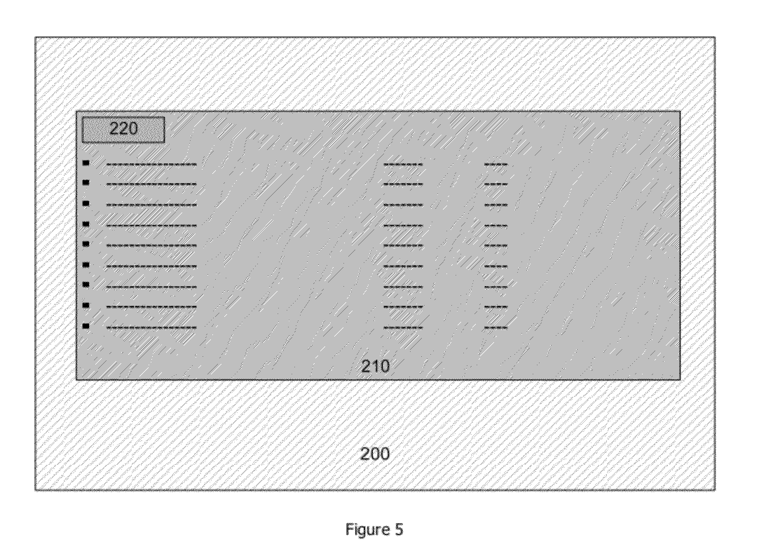

When viewing the field properties of a newly added or existing extension field in key user tool 190, a user may select the “Further Usage” button 192 to drive the selected extension field into a specific form template 110. FIG. 5 illustrates a further usage of the extension field into a specific form template. Window 200 may display the selected extension field and the business context for the form template (such as sales, returns, etc.). Window 200 may also contain list box 210. List box 210 may have multiple tabs, including a tab corresponding to the form templates that are associated with the given business context. A user may scroll to the desired form template and click on button 220, which may allow for adding the field from the user interface 100 to the form template in window 300. Button 220 may be labeled as “Add field and Edit”.

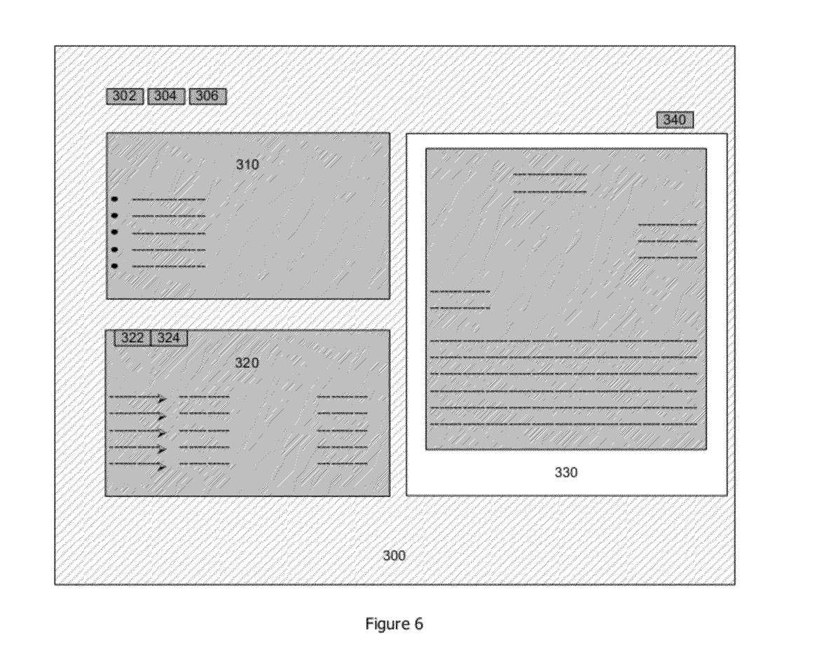

FIG. 6 illustrates adding a customized extension field to a form template from the user interface. A user clicking on button 220 may generate window 300. When a user selects to use the customized extension field to drive a specific form template, the form template 110 is opened and the customized extension field is made available to the template. Application 20 may search into the existing business nodes and reference field 40 and may make the customized extension field only available to applicable sections of interface 100.

The top of window 300 may display information about the selected form template 110 (such as language and country applicable, etc.). Window 300 may also display the title of the form template. A user may save any changes to form template 110 by using save button 302, close the template by using button 304, or publish the template with button 306.

Window 300 may display list box 310 which may display all of the section headers in form template 110. A user may subsequently scroll through the section headers and highlight a desired section header. Window 300 may also display list box 320, which may be displayed directly under list box 310. List box 320 may display extension fields that correspond to the selected header in list box 310. When window 300 is initially generated, after a customized extension field from key user tool 190 is used to drive a form template, list box 320 may display the customized extension field automatically at the top of the list of extension fields. The customized extension field may only be available to section headers in list box 320 that are applicable to the customized extension field. If a non-applicable section header is selected, the customized extension field may not be available to that section and may not be displayed in list box 320.

List box 320 may be divided into three separate columns. In a first column, a user may select the visibility of each of the extension fields. From a drop down list, a user may select for each extension field from three settings: “Show always”, “Show if exists”, and “Do not show”. The “Show always” setting may show the extension field even if no data was input by a user into the form template 110 in panel 130. The “Show if exists” setting may show the extension field only if data was input for the extension field in panel 130. The “Do not show” setting may not show the extension field even if input data was entered by a user in panel 130.

In a second column in list box 320, a label for each of the extension fields may be displayed. A third column in list box 320 may display a description of the extension field. A user may scroll through the extension fields to select and change the visibility of each respective extension field, including the initially selected extension field by key user tool 190. In an embodiment, list boxes 310 and 320 may be the same size. If there are more section headers or extension fields then allowed for in the area provided in list boxes 310 and 320, a scroll bar may allow for the additional viewing of non-displayed headers or extension fields.

Extension fields from each of the section headers may be removed in window 300 from form template 110, by using remove button 324. Extension fields made available to other relevant section headers may be added to those section headers by using the add button 322.

The selected form template 110 may be embedded in a print view in viewing pane 330. Viewing pane 330 may display form template 110 as a file such a PDF, a word document, or any other text-based document. Viewing pane 330 may display form template 110 using provided sample data. If a user wishes to change the data displayed in the viewing pane, the user may click on the “Change Sample Data” button 340, which may be displayed above viewing pane 330. Button 340 may be used to tailor form template 110 to each desired set of data. Viewing pane 330 may also contain a menu bar with a number of icons that provide for the printing, saving, and zooming, of the template. Viewing pane 330 may also contain a scroll bar which may allow a user to scroll and view the entire document which may not fit in the display area of the viewing pane.

When the visibility setting of an extension field in list box 320 is changed, the corresponding change may occur in the preview document in viewing pane 330 after refreshing application 20. A selection of “Show always” for the visibility of a selected extension field may add the extension field to the preview document in viewing pane 330. A selection of “Show if exists” may make the selected extension field visible in viewing pane 330 only if data was input to the interface in panel 130. A selection of the setting “Do not show” may hide the extension field in the preview document in viewing pane 330. A user may save their selection to form template 110 by the save button 302 or publish the template via button 306.

Any suitable technology may be used to implement embodiments of the present invention, such as general purpose computers. One or more system servers may operate hardware and/or software modules to facilitate the inventive processes and procedures of the present application, and constitute one or more example embodiments of the present invention. Further, one or more servers may include a computer readable storage medium, with instructions to cause a processor, e.g., processor 30, to execute a set of steps according to one or more example embodiments of the present invention.

Further, example embodiments of the present invention are directed to one or more processors, which may be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination. The one or more processors may be embodied in a server or user terminal or combination thereof. The user terminal may be embodied, for example, a desktop, laptop, hand-held device, Personal Digital Assistant (PDA), television set-top Internet appliance, mobile telephone, smart phone, etc., or as a combination of one or more thereof. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor which, when executing the series of computer instructions, performs or facilitates the performance of all or part of the disclosed methods and procedures.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A method for adding a customized extension field to a form template by an application displayed on a monitor, the method comprising:
running the application in an adaptation mode, wherein the application is executed by a processor;
selecting a section of the form template to add the customized extension field;
inputting data by a user corresponding to a business context and a field type of the customized extension field;
upon selecting the form template to add the customized extension field to, generating a preview of the form template in a viewing pane with the customized extension field;
enabling visibility of the customized extension field based on a chosen visibility setting; and
automatically authorizing addition of the customized extension field to other sections of the form template if the customized extension field is applicable to the other sections.

2. The method according to claim 1, wherein the customized extension field is visible in the form template in all instances.

3. The method according to claim 1, wherein the customized extension field is visible in the form template only if data exists for the customized extension field.

4. The method according to claim 1, wherein the customized extension field is not visible in the form template.

5. The method according to claim 1, wherein the preview of the form template is a PDF file.

6. The method according to claim 1, wherein changes to the visibility of the customized extension field are shown after refreshing the application.

7. The method according to claim 1, further comprising:
controlling visibility settings of other displayed extension fields of the selected section.

8. The method according to claim 1, further comprising:
selectably switching to one of the other sections of the form template; and
adding the customized extension field to the switched section of the form template, if the switched section is permitted to add the customized extension field.

9. The method according to claim 1, further comprising:
using a reference field to add the customized extension field, the reference field pointing to a user interface and a corresponding business object.

10. The method according to claim 1, further comprising:
searching a plurality of business objects for the customized extension field.

11. The method according to claim 9, further comprising:
reading the reference field and creating runtime artifacts for the application that are stored locally.

12. The method according to claim 11, wherein the runtime artifacts are deleted and regenerated when changes are made to the customized extension field or the corresponding business object.

13. A computer readable medium having a program which is executable by a processor for performing a method for adding a customized extension field to a form template, the method comprising:
selecting a section of the form template to add the customized extension field;
inputting data corresponding to a business context and a field type of the customized extension field;
upon selecting the form template to add the customized extension field to, generating a preview of the form template in a viewing pane with the customized extension field;
enabling visibility of the customized extension field based on a chosen visibility setting; and
authorizing addition of the customized extension field to other sections of the form template if the customized extension field is applicable to the other sections.

14. The method according to claim 13, wherein the customized extension field is visible in the form template in all instances.

15. The method according to claim 13, wherein the customized extension field is visible in the form template only if data exists for the customized extension field.

16. The method according to claim 13, wherein the customized extension field is not visible in the form template.

17. The method according to claim 13, wherein the preview of the form template is a PDF file.

18. The method according to claim 13, wherein changes to the visibility of the customized extension field are shown after refreshing the application.

19. The method according to claim 13, further comprising:
controlling visibility settings of other displayed extension fields of the selected section.

20. The method according to claim 13, further comprising:
selectably switching to one of the other sections of the form template; and
adding the customized extension field to the switched section of the form template, if the switched section is permitted to add the customized extension field.

21. The method according to claim 13, further comprising:
using a reference field to add the customized extension field, the reference field pointing to a user interface and a corresponding business object.

22. The method according to claim 13, further comprising:
searching a plurality of business objects for the customized extension field.

23. The method according to claim 21, further comprising:
reading the reference field and creating runtime artifacts for the application that are stored locally.

24. The method according to claim 23, wherein the runtime artifacts are deleted and regenerated when changes are made to the customized extension field or the corresponding business object.
